(19) United States
(12) Patent Application Publication
(10) Pub. No.: US 2011/0202646 A1
(43) Pub. Date: Aug. 18, 2011

(54) POLICY CONTROLLED TRAFFIC OFFLOAD VIA CONTENT SMART-LOADING

(76) Inventors: Randeep S. Bhatia, Green Brook, NJ (US); Hyunseok Chang, Holmdel, NJ (US); Mark Anthony Smith, Jersey City, NJ (US)

(21) Appl. No.: 12/705,628

(22) Filed: Feb. 14, 2010

(51) Int. Cl. G06F 15/173

(52) U.S. Cl. 709/223

(57) ABSTRACT

An example method includes receiving at a user device a policy from a communication network node, and loading the user device with content data based on the policy. The policy specifies a rule set and a corresponding action to undertake in the event of a condition satisfying the rule set and may be received at the user device in response to connection of the user device to the network node. The policy received may be an updated policy, and may be based on network conditions. Example apparatuses and methods determine how (for example, what access technology and what times, to best deliver content given the particulars for a user and the device state of the user, using a rules set that can be dynamically updated without user intervention by network operators based on network management policies. Delivery includes upload, download and sideload of a user device.

### FIELD OF THE INVENTION

The invention relates to the control of the transfer of data between content repositories and user devices.

### BACKGROUND

The ever-increasing capabilities of user devices continue to drive bandwidth demand. For example, the recent introduction of video-enabled mobile devices is likely to stimulate growing demand for downlink and uplink bandwidth as users increasingly share data content with friends and associates. Moreover, users will increasingly wish to access and share data content, such as movies and books, now that their user devices include the capability of easily creating and sharing such data content. Further, as additional user-valued data content and services become and are made more readily available, bandwidth demand will increase. For similar reasons, the transfer of data over wired networks is also expected to increase in the future. Accordingly, wired and wireless operators are expected to experience a growing problem caused by heavy data usage and the resultant detrimental effects, such detrimental effects including increased content delivery failure, inability to serve all users, increase operator and user costs for the delivery of content, and the like.

One solution that network operators and users have implemented to address increased data usage and its associated effects is smart-loading utilizing unused Bandwidth (e.g., during off-peak hours), cost effective access (e.g. side-loading over WiFi, Femto, etc.) and user terminal content pre-caching. The advantage of such a solution is that by caching personalized and/or popular content on a user device, the user's request for the content can be (fully or partially) served locally thus minimizing network access at peak times and improving the use experience. For example, user devices such as smartphones, laptops, and netbooks typically have multiple network access technologies, such as 3G, WiFi, Bluetooth and the like, which enable the user device to be mobile. When content is being delivered to/from these mobile devices (e.g., for pre-caching on the device, video upload, etc.), a choice has to be made as to which network access technology to use for the data transfer. Similarly, a particular date and/or time can be selected for the delivery of content so content deliver occurs when the user is not normally using the device (e.g., overnight during sleeping hours instead of during normal active or working hours) or less likely to incur roaming costs (e.g., while at home as opposed to when roaming). In addition to the selection of network access technology and date/time, other factors such as device usage pattern and device state may also play a role in determining how and when to deliver content. Conventional access solutions thus address the issue of what access technology and what times are best to deliver content given the particulars for user and the device state of the user.

### SUMMARY

The following presents a simplified summary of the disclosed subject matter in order to provide an understanding of some aspects of the disclosed subject matter. This summary is not an exhaustive overview of the disclosed subject matter and is not intended to identify key or critical elements of the disclosed subject matter not to delineate the scope of the disclosed subject matter. Its sole purpose is to present some concepts in a simplified form as a prelude to the more detailed description that is discussed later.

Network operators face a growing problem due to heavy data usage associated with user devices including smartphones (e.g., iPhone). Increased data usage has the potential to detrimentally cause increased content delivery failure, inability or degraded ability to serve user devices, increased costs for content delivery, and the like. I the face of such problems, existing access solutions apply limited intelligence on an individual user basis and are not an efficient mechanism for automated content delivery across different access technologies as well as under changing user/device/network conditions.

For instance, existing access solutions for access switchover are based on simple policies that are built into the user device (e.g., for switchover across 3G and WiFi). In addition, in these access solutions, users may also have the limited ability to instruct the access switching themselves (e.g., instructing the connection to a WiFi hotspot) or establish a schedule for content delivery. However, in these solutions any ongoing content delivery flows are not continued after the access switch and the user must restart the content delivery from the beginning, leading to unnecessary waste of scarce radio and backhaul resources. Moreover, these types of vertical handoff mechanisms are typically hardcoded into the device, and so their behavior can not be controlled by the user or operator and also can not take into account other information such as device, network and user state. In addition, scheduling established by individual users under existing solutions is performed on an ad hoc basis without accounting for other users or the network state. Thus, these solutions which apply limited intelligence are less than optimal and do not provide efficient mechanisms for automated content delivery across different access technologies as well as under changing user/device/network conditions.

Example apparatuses and method are provided that determine what access technology and what times are best to deliver content given the particulars for a user and the device state of the user, and to do this in a way that does not require user intervention, and can be dynamically updated by operators based on their network management policy.

Provided are policy based schemes for determining the best delivery opportunities, including the bearer (access) on which delivery takes place, for user devices, including mobile devices. A policy controlled algorithm, so-called policy engine, considers a range of device and network conditions (e.g. channel quality, bearer availability, battery status, powering status, processor occupancy) to make the determination. The actual policy that drives the algorithm can be updated by an operator and reloaded (pushed) to a user device at any time without user intervention. In this manner, the proposed methodology enables flexible delivery optimization based on various different criteria which can potentially change according to operator's network management policy. Thus, the described apparatuses and methods enable a more effective utilization of network resources and device resources (e.g., implementation of delivery scheduling changes for network events, battery life for mobile devices, etc.) for user devices while providing an improved user experience.

In one embodiment, a method comprises receiving at a user device a policy from a communication network node, and loading the user device with content data based on the policy, wherein the policy specifies a rule set and a corresponding action to undertake in the event of a condition satisfying the rule set.

The policy may be received at the user device in response to connection of the user device to the network node. The policy that is received may be an updated policy. And, the updated policy may be based on network conditions.

In one embodiment, loading the user device with content data comprises at least one of receiving content data at the user device, downloading the user device with content data, uploading content data from the user device, and sideloading the user device. The rule set includes at least one criterion for the condition. The condition may be a network state parameter, network parameter, a user device state parameter, or a user device parameter.

The condition may be a parameter indicative of a battery status, a powering status, a processor utilization, a polling interval, a background downloading permission, a memory occupancy, a channel quality, a quality of service, a measured bandwidth, a bearer availability, a roaming state, a content data availability, a content data priority, or a policy change status.

The corresponding action may be at least one of starting the loading of the user device, stopping the loading of the user device, suspending the loading of the user device, resuming the loading of the user device, switching a bearer to be utilized for the loading of the user device, selecting a next job comprising content data for loading of the user device. The rule set may include at least one category addressing a network connection type, at least one category addressing access preferences, or some combination thereof.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting, and wherein:

FIG. 1 illustrates an example network for implementing policy controlled traffic communication as disclosed herein;

FIG. 2 illustrates a client content caching client in an exemplary embodiment of a user device according to the principles of policy controlled traffic communication disclosed herein; and

FIGS. 3a and 3b are a flow charts illustrating one example embodiment of a method for policy controlled traffic communication.

### DETAILED DESCRIPTION

Various example embodiments will now be described more fully with reference to the accompanying figures, it being noted that specific structural and functional details disclosed herein are merely representative for purposes of describing example embodiments. Example embodiments may be embodied in many alternate forms and should not be construed as limited to only the embodiments set forth herein.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. As used herein the description, the term “and” is used in both the conjunctive and disjunctive sense and includes any and all combinations of one or more of the associated listed items.

Unless otherwise defined, all terms (including technical and scientific terms) used herein have the same meaning as commonly understood by one of ordinary skill in the art to which example embodiments belong. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

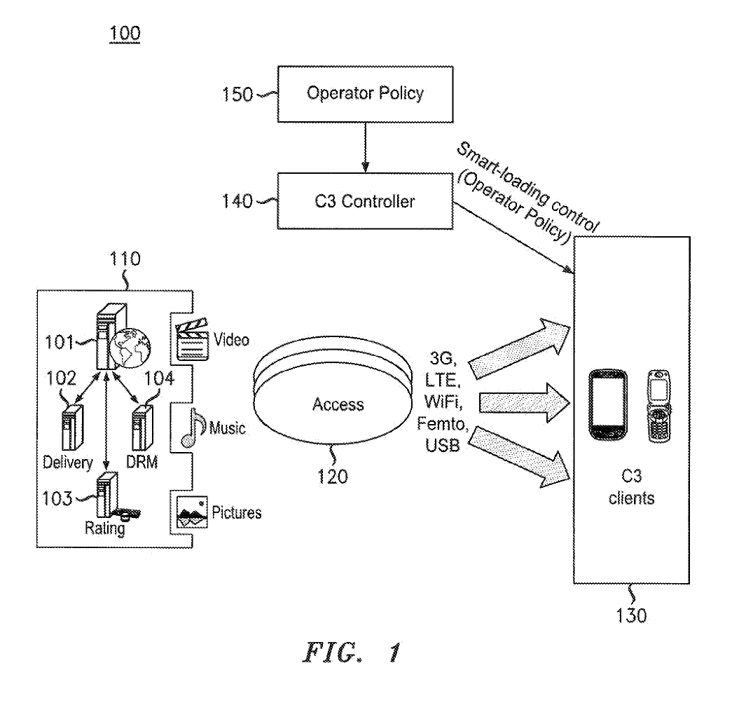

FIG. 1 illustrates an example network for implementing policy controlled traffic loading. The network 100 of FIG. 1 include content repository 110 which is reachable by client content caching (C3) clients 130 via communication over access network 120. The content repository 110 includes content data of interest to user devices. Such content data may include video, music, pictures and the like. The content repository 110 includes a managing server 101 which controls the communication of content data between the content repository and the access network 120. The managing server 101 of the content repository 110 also communicates internally with delivery server 102, rating server 102 and Digital Rights management (DMR) server 104. These servers are utilized to further mange a user's relationship with the content repository and ensure that appropriate access to content data is granted only at appropriate dates/times, under appropriate re/viewing conditions to appropriate viewers. For example, these servers may support policy enforcement and content-based charging.

Access network 120 handles the physical communication between the content repository 110 and the C3 clients 130. One example of a network that can support the provided methods is provided by Long Term Evolution (LTE), a Fourth Generation enhancement to Universal Mobile Telecommunications System (UMTS) telecommunication that includes an all-IP networking architecture. LTE is being introduced through a series of releases by the 3rd Generation Partnership Project (3GPP). In LTE, the General Packet Radio Service (GPRS) core network is replaced by the System Architecture Evolution (SAE), which is a flat, IP-based network architecture. Because LTE is all-IP from end to end, mobile handsets and other terminal devices for LTE have embedded IP capabilities, and the base stations, referred to as Evolved NodeBs (eNodeBs) are IP-based. Those skilled in the art will understand that the principles of the present invention may be implemented in any suitably arranged telecommunications network. For example, the access network may be a 3G network, a WiFi network a USB network or any suitable network for communication from one point to another point. For instance, in another example, the access network may be the internet to which user devices are hardwired.

The access network supports operator-defined policy for resource allocation and usage, packet filtering, and charging. The access network also performs the signaling and control functions to manage the user device access to network connections, the assignment of network resources, and the management of the mobility states to support tracking, paging, roaming, and handovers, as well as all other control-plane functions related to subscriber and session management.

Access network also includes a C3 controller which provides the policy engine, as will be further explained below, to the C3 clients. The policy engine held by the C3 controller may be maintained or updated by operator policy 150. The operator policy allows a network operator to policies for access to the operator network based on network conditions. For example, if its network is undergoing a maintenance upgrade, a network operator may disallow certain types of content delivery options. For example, network operator may disallow certain types of content delivery options if a particular network is experiencing high use. The operator may input the operator policy using an operator policy application interface 150 and thereby provide an operator policy to the C3 controller.

The C3 controller can intercommunicate with the various elements of the access network. For example, the C3 controller may communicate using known protocols of the Internet protocol suite. Higher protocol layers are used for the signaling and messaging that set up the loading of content data. The C3 controller may reside on any of various hardware platforms, such as an ATCA platform. In one embodiment, the IVM may be incorporated into a node of the access network, such as a Packet Data Network Gateway (PGW).

The C3 controller 140 and the content repository 110 communicate with C3 clients over the access network. Communication between the C3 controller and the various user devices may be effectuated by a protocol layer added on top of LTE. Toward that end, user devices 130 include C3 clients for communication with C3 controller. The required protocol layer is readily added using known protocols, and need not be described here in detail.

A user device may be a User Equipment (UEs), which is any suitable wireless devices or mobile station, including conventional cellular radiotelephones, PCS handset devices, personal digital assistants, portable computers, and the like, which are capable of communicating with the via wireless links. The user device may also are alternatively communicate with the access network over a wired link.

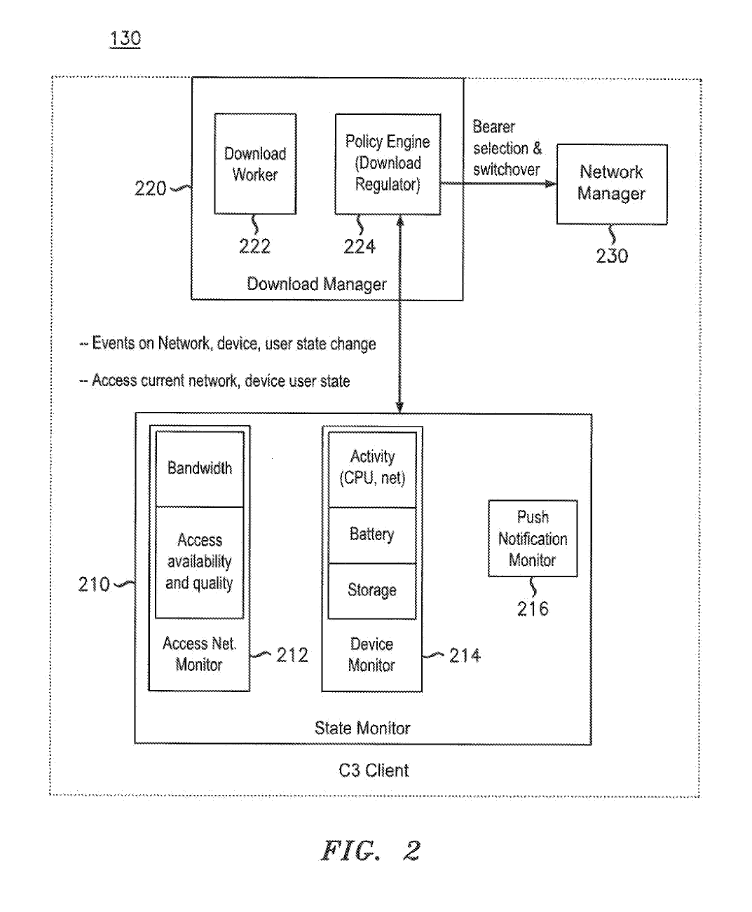

FIG. 2 illustrates a client content caching (C3) client in an exemplary embodiment of a user device according to the principles of policy controlled traffic communication. According to an embodiment, a policy based scheme determines the preferred content delivery opportunities, including the bearer (access) on which delivery takes place, for user devices, including mobile devices. A policy controlled algorithm, so-called policy engine, considers a range of device and network conditions (e.g. channel quality, bearer availability, battery status, powering status, processor occupancy) to make the determination. The actual policy that drives the algorithm can be updated by operator and reloaded to a device at any time without user's intervention.

The provided embodiments of methodology enable flexible delivery optimization based on various different criteria which can potentially change according to operator's network management policy. Using policy-controlled smart background loading the problems associated with heavy data usage that are faced by network operators can be addressed. Thus, a more effective utilization of network resources and device resources (e.g. battery life) for wireless devices may be provided while simultaneously providing the user an improved experience.

The C3 application for a user device includes a state manager 210, a download manager 220 and a network manager. The state manager includes an access network manager 212, a device monitor 214 and a push notification manager 216. The access network manager 212 monitors conditions such as network state parameters, network parameters. The device monitor 214 monitors conditions such user device state parameters and user device parameters. The push notification manager 216 monitors changes in the state of the network operator policy. For example, the state monitor 210 may monitor conditions such a parameter indicative of a battery status, a powering status, a processor utilization, a polling interval, a background downloading permission, a memory occupancy, a channel quality, a quality of service, a measured bandwidth, a bearer availability, a roaming state, a content data availability, a content data priority, a policy change status, or some combination thereof.

The download manager 220 includes a download worker 222 and a policy engine (download regulator) 224. The Policy Engine (PE) is responsible for scheduling starting, stopping and resuming all jobs. The PE is started up at boot up time as part of starting up C3. It runs by itself in its own thread. The PE enforces:

the content item delivery priorities (ordering) as specified in the Content Inventory file;

the Policy that specifies the set of actions to take when the network or device state changes.

The PE gets updates on:

the changes in the device and network state reported by the State Monitor Component. This includes battery condition, measured bandwidth, bearer availability, roaming state, etc.;

the PE is also informed if some parameters (e.g. polling intervals, background downloading flag etc.) are updated by the user via client control panel.

The PE also responds to any push notifications received from the C3 control server.

The PE executes the rules of the Policy under the new state/parameters to determine what steps to take. These steps could include:

stopping or resuming the current delivery of content data;

switching the current job in favor of another higher priority job (e.g. suspending the delivery of the current content item to download the latest operator's policy as triggered by a push notification sent by the C3 control server); selecting the next job to process;

switching the bearer to use for delivery (utilizes the service of the Network Manager component) for this content data; and

time interval to wait for to process the next event

The PE can use policies it “downloads” from the C3 Control Server. These polices can be based on available bandwidth, network conditions, battery life, central processor unit utilization, etc.

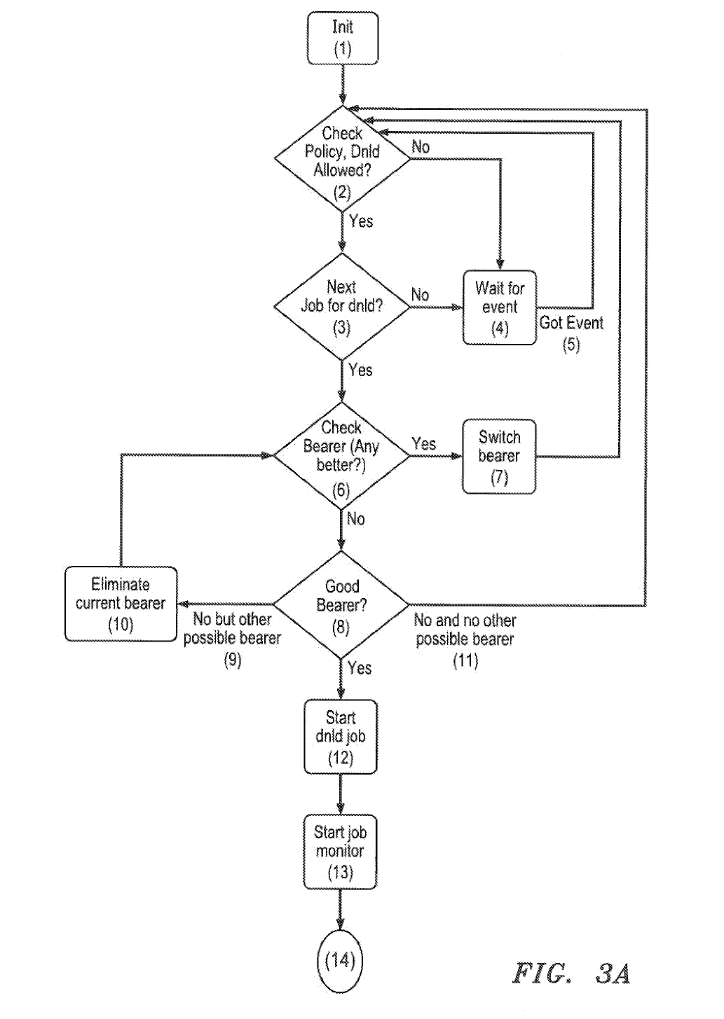

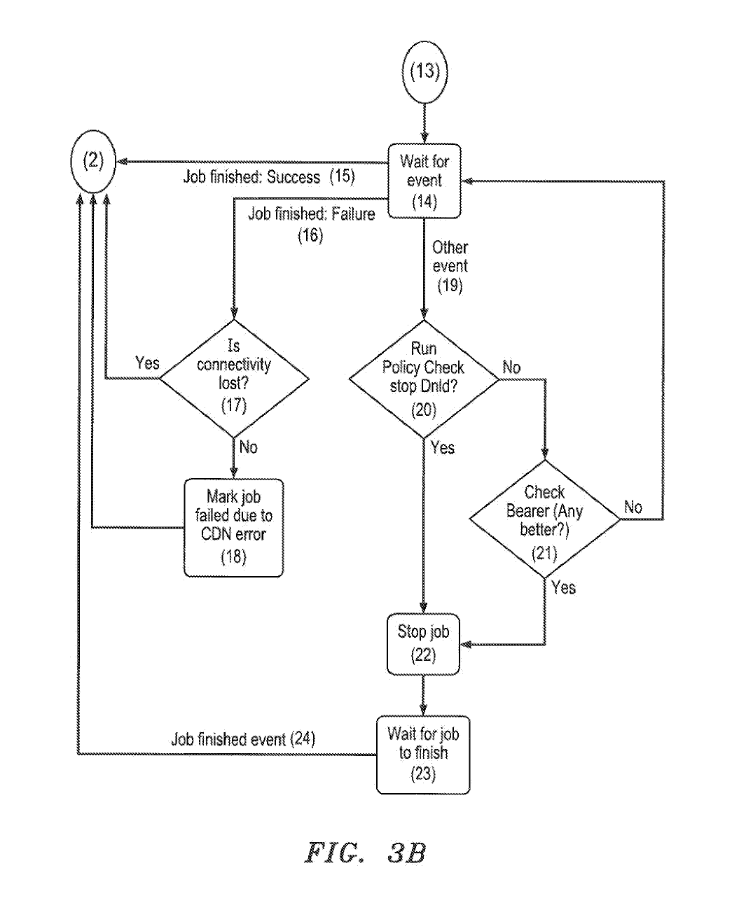

FIGS. 3a and 3b are a flow charts illustrating one example embodiment of a method for policy controlled traffic communication. While the detailed explanations of the steps of the policy engine algorithm below are described in the context of content data download, they apply to all aspects of content smart-loading including uploads, side-loads, etc., and the like. The steps of method will be described with reference to C3 client of FIG. 2 in the network of FIG. 1, but those skilled in the art will appreciate that method may be performed in other networks and systems. In addition, the steps of the flow charts described herein are not all inclusive and may include other steps not shown. The steps may also be performed in an alternative order.

With reference to FIG. 3a, C3 client is initiated at step 1. At step 2, the methodology checks if download of content data is allowed according to the network operator's policy. The download may be blocked due to constraints on the current device, or user state as mandated by the operator's policy. This could include low battery, background download disabled, etc. In this step, download may also be blocked due to the poor bearer quality (e.g. low BW) as reported by the State Monitor (e.g. BW monitor) or due to the terminal involved in other network activity.

In step 3, the methodology checks if there is a job that is ready to be downloaded and the highest priority job is picked.

Alternatively, in step 4, the methodology waits to be notified of an event (e.g., as reported by the State Manager). These events could be battery being charged, conten data available and ready to be downloaded, new access discovered, background download enabled, push notification received, etc.

Step 6 is reached if download is allowed and a job is ready for download. Here, the methodology checks for the available bearers and tries to pick the best bearer as determined by the policy, switching bearer in step 7 as necessary to determine the preferred bearer for content data delivery. A bearer is not to be considered if it is not currently allowed by operator's policy (e.g., 3G bearer not allowed during rush hour).

In step 8, the methodology checks if the current bearer is good. For example, the bearer may be bad if there is no connectivity.

In step 9, there still exists an unexplored bearer that is allowed by the operator's policy so, in step 10, the current bearer is assumed to be disabled so that the methodology eliminates the current bearer from consideration when evaluating bearers.

In step 11, when the current bearer not good and there are not other possible bearers, the methodology returns to the policy check state 2.

In step 12, the content data delivery job is initiated. At step 13, download job is monitored to see if the job succeeded or failed, and to get BW/quality of the current download. This essentially refers to starting the corresponding monitor in the State Manager.

Step 14 is similar to step 2, except in step 14 the methodology now obtains other events on the status of the job being downloaded and the quality of the current bearer.

In step 15, the content data delivery job finishes successfully. In step 16, the content data delivery job finishes unsuccessfully. In steps 17 and 18, the methodology evaluates the cause of the download failure. If the failure is due to lost connectivity, then the bearer is marked as failed to see if the job can be resumed on a different bearer or if connectivity can be restored for the current bearer after a wait period. If the failure is due to other reasons, then the job is marked as failed only to be retried after some provisioned retry interval.

In step 20, the methodology checks if the job needs to be stopped due to other event (step 19) indicating some change in the device, user, network state or due to some push notification from the server. If the policy check indicates that the download is to be stopped, at step 22, the methodology stops the data content delivery job and make sure the job is finished (step 23) before starting a new job. The conclusion of the job is indicated by a job finished event (step 24). The download monitor reports this event. If the policy check does not indicate that the download is to be stopped, at step 21, the methodology searches for a bearer better able to complete the data content delivery.

The following is a sample list of policies that the C3 client PE is able to support. The list is just an illustration of one way that policies could be specified. Once again, the policies are described in the context of content data download but apply to all aspects of content smart-loading including uploads, side-loads, etc.

The policies may be classified into a number of categories. Some of these categories may indicate when the download needs to be suspended. Other policies may resolve ties when multiple access options are possible in order to make a unique choice (based on operators preference, tarrif, etc. and the like).

Category 1: Global Stop→ Download is immediately suspended if any of these criteria apply:

A. Stop download (Unconditional background download stop).

B. Stop download if Battery<20% and not being charged.

C. Stop download if BW<20 KBps.

D. Stop download if available storage<100 MB.

E. Stop download if CPU usage>30%.

F. Stop download if other apps on the phone doing network activity

Category 2: Femto Stop→ Download is immediately suspended if any of these criteria apply when on a Femto network:

A. Stop download (Unconditional background download stop if on Femto network).

B. Stop download if BW<100 KBps.

C. Stop download if RSSI (signal strength)<Z dbm.

Category 3: WiFi Stop→ Download is immediately suspended if any of these criteria apply when on WiFi network:

A. Stop download (Unconditional background download stop if on WiFi network).

B. Stop download if BW<100 KBps.

C. Stop download if SSID not in <SSID set>.

D. Stop download if RSSI (signal strength)<Y dbm.

Category 4: 3G Stop→ Download must be immediately suspended if any of these criteria apply when on a 3G network:

A. Stop download (Unconditional background download stop if on 3G network).

B. Stop download if day time.

C. Stop download if BW<30 KBps.

D. Stop download if roaming.

E. Stop download if Cell ID not in <Cell ID set> (For Femto case).

F. Stop download if RSSI (signal strength)<X dbm.

G. Stop download if on 2.5G network.

Category 4: Access Preference (tie breaking) and parameters

A. Prefer WiFi over 3G.

B. Prefer wired over wireless.

The provided methodology is more flexible than the existing access handover mechanisms because of the fact that it is policy driven and the policy can be updated on the fly without user's intervention. Also, because the policies are actively involved in scheduling the delivery based on various network and device states, the provided methodology better utilizes network and device resources. The provided C3 application for user devices addresses the network operator's problem of heavy data usage through the user of policy-controlled smart background loading.

Various of the functions described above with respect to the exemplary method are readily carried out by special or general purpose digital information processing devices acting under appropriate instructions embodied, e.g., in software, firmware, hardware or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module. For example, functional modules of the DSP and the other logic circuits can be implemented as an ASIC (Application Specific Integrated Circuit) constructed with semiconductor technology and may also be implemented with FPGA (Field Programmable Gate Arrays) or any other hardware blocks.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

What is claimed is:

1. A method comprising:
receiving at a user device a policy from a communication network node; and
loading the user device with content data based on the policy, wherein the policy specifies a rule set and a corresponding action to undertake in the event of a condition satisfying the rule set.

2. The method of claim 1 wherein the policy is received at the user device in response to connection of the user device to the network node.

3. The method of claim 1 wherein the policy that is received is an updated policy.

4. The method of claim 1 wherein the updated policy is based on network conditions.

5. The method of claim 1 wherein loading the user device with content data comprises at least one of receiving content data at the user device, downloading the user device with content data, uploading content data from the user device, and sideloading the user device.

6. The method of claim 1 wherein the rule set includes at least one criterion for the condition.

7. The method of claim 1 wherein the condition is a network state parameter, network parameter, a user device state parameter, or a user device parameter.

8. The method of claim 1 wherein the condition is parameter indicative of a battery status, a powering status, a processor utilization, a polling interval, a background downloading permission, a memory occupancy, a channel quality, a quality of service, a measured bandwidth, a bearer availability, a roaming state, a content data availability, a content data priority, or a policy change status.

9. The method of claim 1 wherein the corresponding action is at least one of starting the loading of the user device, stopping the loading of the user device, suspending the loading of the user device, resuming the loading of the user device, switching a bearer to be utilized for the loading of the user device, selecting a next job comprising content data for loading of the user device.

10. The method of claim 1 wherein the rule set includes at least one category addressing a network connection type.

11. The method of claim 1 wherein the rule set includes at least one category addressing access preferences.

12. A user device comprising a client configured to
receive a policy from a network node of an access network; and
load content data based on the policy, wherein the policy specifies a rule set and a corresponding action to undertake in the event of a condition satisfying the rule set.

13. The user device of claim 12 wherein the client comprises:
a state manager, the state manager configured to monitor the user device and the access network

14. The user device of claim 12 wherein the client comprises:
a download manager configured to determine when a condition satisfies the rule set.

15. The user device of claim 12 wherein the download manager is further instruct the network manager to undertake a corresponding action.

16. The user device of claim 12 wherein the download manager is further configured to manage the loading of content data.

17. The user device of claim 12 wherein the client comprises:
a network manager configured to manage the bearer connection to the access network.

18. A computer readable medium having stored thereon instructions comprising machine executable code which when executed by at least one processor, causes the processor to
receive at a user device a policy from a communication network node; and
load the user device with content data based on the policy, wherein the policy specifies a rule set and a corresponding action to undertake in the event of a condition satisfying the rule set.
